(19) United States
(12) Patent Application Publication
(10) Pub. No.: US 2024/0406826 A1
(43) Pub. Date: Dec. 5, 2024

(54) X2 Connection Between eNBs Connected Across Different MMEs

(71) Applicant: Parallel Wireless, Inc., Nashua, NH (US)

(72) Inventors: Lakhan Sharma, Pune (IN); Pankaj Bunde, Pune (IN); Sunil Jamkhandikar, Pune (IN)

(21) Appl. No.: 18/656,592

(22) Filed: May 6, 2024

Related U.S. Application Data
(60) Provisional application No. 63/500,588, filed on May 6, 2023.

(51) Int. Cl. H04W 36/14; H04W 36/00; H04W 92/20

(52) U.S. Cl. CPC H04W 36/142; H04W 36/0061; H04W 92/20

(57) ABSTRACT

A mechanism is disclosed for establishing X2 connection between two eNB's (S1 connected to different MME's) by making use of the S10 interface between two MME's. During the Inter MME Handovers, instead of doing an S1 Handover, we leverage the advantages of the X2 interface between two eNB's and offload the Handover load from the EPC core and will concentrate that on the individual eNB's across which the handover needs to be performed, through X2 interface. Additionally, through these X2 connections we will be able to utilize the load management and the mobility parameters management functions of the x2 interface as well.

### CROSS-REFERENCE TO RELATED APPLICATIONS

The present application claims the benefit of priority under 35 U.S.C. § 119 (c) to U.S. Provisional Patent Application 63/500,588, having the same title as the present application and filed May 6, 2023, which is also hereby incorporated by reference for all purposes in its entirety.

The present application also hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); Ser. No. 15/713,584 (PWS-71850US03); US20240040572A1; US20230269633A1.

### BACKGROUND

The X2 interface and X2 Application protocol are a defined interface and protocol for providing point-to-point communication between two eNB's within an LTE radio access network. X2 interface supports the exchange of control information and supports the user plane between two eNB's.

X2 Application Protocol (X2AP) is used in the control plane and a GTP-U Tunnel per bearer is provided for data forwarding in the user plane. X2 interface is defined and specified in 3GPP specification 36.420 and the X2 Application Protocol is defined and specified in 3GPP specification 36.423; and, to establish the X2 connection, the Source eNB need to obtain the Transport Layer Address of the Target eNB i.e obtained using the TNL Procedure (eNB Configuration Transfer & MME configuration Transfer messages) which are defined and specified in 3GPP Specification 36.413; which are hereby incorporated by reference in their entirety.

S10 interface is a control plane interface between MME's. This interface is based on the GTP-C protocol. It is a many-to-many interface. It is used basically during the Inter MME Tracking Area Updates (TAU) and Handovers. GTP-C protocol is defined and specified in 3GPP Specification 29.274 and the call flows for the Inter MME TAU and Handover are defined and specified in 3GPP specification 23.401, which are hereby incorporated by reference in their entirety.

### SUMMARY

In a first embodiment, a method is disclosed for handover across management entities, the method comprising: receiving, at a first management entity, a message from a target base station reflecting a requested X2 handover, the message including a globally unique management entity identifier; determining, at the first management entity, that the target base station identified in a received configuration transfer message from a source base station may be not managed by the first management entity; and receiving, at the first management entity, a transport layer address of the target base station from a second management entity, thereby providing handover across management entities.

The method may further comprise: receiving, from the second management entity at the first management entity, a context request message; and sending, to the second management entity from the first management entity, an S1AP identifier of a user equipment (UE) requesting handover to the target base station.

The management entities may be Long Term Evolution (LTE) mobility management entities (MMEs), the target base station may be an LTE eNodeB, and the globally unique management entity identifier may be a globally unique mobility management entity identifier (GUMMEI).

The method may further comprise sending a broadcast configuration transfer message to multiple management entities connected to the first management entity to request the transport layer address of the target base station.

The method may further comprise sending a configuration transfer initiation message to the source base station using the transport layer address of the target base station received from the second management entity.

The method may further comprise causing a serving gateway (SGW) to complete a bearer context update for the UE reflecting that the UE has moved to the target base station.

The method may further comprise performing data forwarding during a handover execution phase.

In a second embodiment, a computer-readable medium is disclosed containing instructions which, when executed on a processor at a management entity in a mobile network, cause the management entity to perform operations, the operations comprising: receiving, at a first management entity, a message from a target base station reflecting a requested X2 handover, the message including a globally unique management entity identifier; determining, at the first management entity, that the target base station identified in a received configuration transfer message from a source base station may be not managed by the first management entity; and receiving, at the first management entity, a transport layer address of the target base station from a second management entity, thereby providing handover across management entities.

The instructions may further comprise: receiving, from the second management entity at the first management entity, a context request message; and sending, to the second management entity from the first management entity, an S1AP identifier of a user equipment (UE) requesting handover to the target base station.

The management entities may be Long Term Evolution (LTE) mobility management entities (MMEs), the target base station may be an LTE eNodeB, and the globally unique management entity identifier may be a globally unique mobility management entity identifier (GUMMEI).

The instructions may further comprise sending a broadcast configuration transfer message to multiple management entities connected to the first management entity to request the transport layer address of the target base station.

The instructions may further comprise sending a configuration transfer initiation message to the source base station using the transport layer address of the target base station received from the second management entity.

The instructions may further comprise causing a serving gateway (SGW) to complete a bearer context update for the UE reflecting that the UE has moved to the target base station.

The instructions may further comprise performing data forwarding during a handover execution phase.

### BRIEF DESCRIPTION OF THE DRAWINGS

FIG. 1 is a schematic diagram of an X2 interface in use between eNodeBs, as known in the art.

FIG. 2 is a schematic diagram of an X2 interface in use between eNodeBs, in accordance with some embodiments.

FIG. 3 is a call flow diagram for X2 setup between eNodeBs connected to different MMEs, in accordance with some embodiments.

FIG. 4 is a call flow diagram for inter-MME X2-based handover without SGW change, in accordance with some embodiments.

FIG. 5 is a schematic diagram of an ORAN-compatible deployment architecture, in accordance with some embodiments.

### DETAILED DESCRIPTION

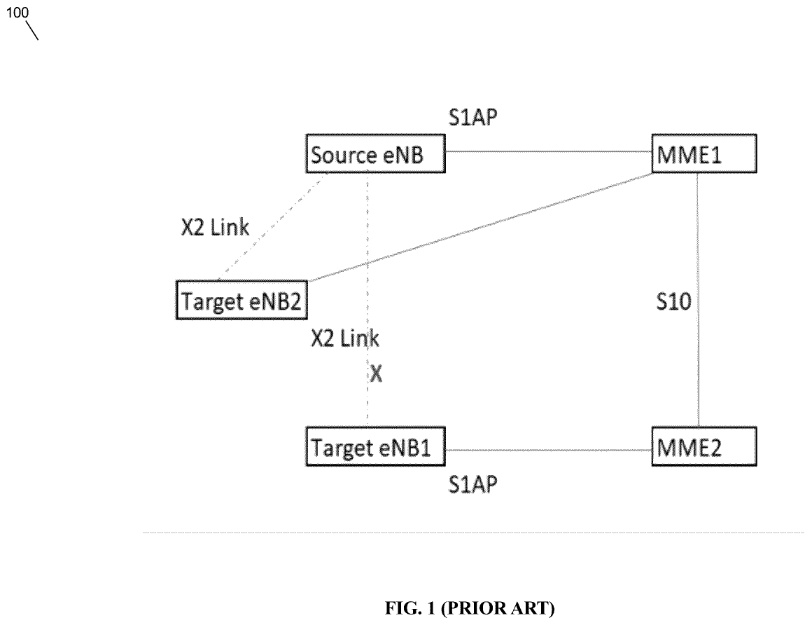

FIG. 1 is a schematic diagram of an X2 interface in use between eNodeBs, as known in the art. No X2 link is possible according to the X2 specification if the source eNB and target eNB1 are associated with different management entities (MME1 and MME2).

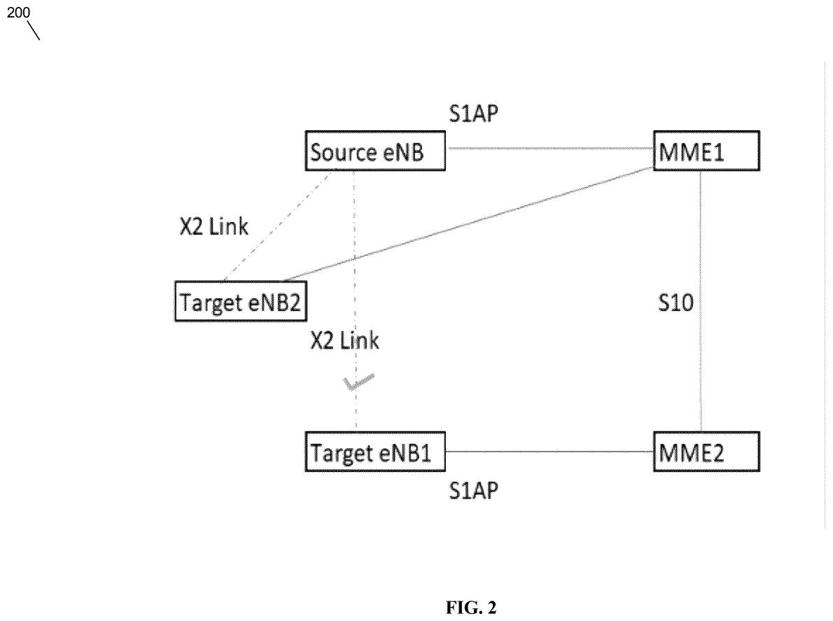

FIG. 2 is a schematic diagram of an X2 interface in use between eNodeBs, in accordance with some embodiments. In this diagram, an X2 link is made to exist between the source eNB and target eNB 1 that are associated with different management entities (MME1 and MME2), as described further herein.

To establish an X2 connection between the two eNB's, the Source eNB needs to perform a TNL Discovery Procedure to obtain the Transport Layer Address of the target eNB. After successful TNL discovery, Source eNB initiates the X2 connection towards the Target eNB on the IP address obtained through TNL Discovery. However, as defined in the 3GPP specification, there is a limitation that TNL Discovery Procedure is successful only in case both the Source and the Target eNB are connected to same MME over S1 interface. Thus, we cannot establish X2 connection and in turn cannot perform X2 Handovers when Source and Target eNB are connected to different MME's.

Because of the above-mentioned reason whenever there is a need to perform a UE Handover from one eNB to another when both are connected to different MME, we cannot perform an X2 Handover and we need to make use of the Inter MME S1 Handover which takes much more signaling toll on the core network compared to that of the X2 Handover.

In case of the S1 HO, all the phases of the Handover i.e Handover Preparation, Handover Execution and Handover Completion along with all the Indirect Data Forwarding processing is to be handled by the core network.

In case of the X2 Handover, Indirect Data Forwarding is handled by the eNB's themselves. SGW's are not involved for indirect data forwarding and MME is involved only during the Handover Completion Phase.

Also, since we are not able to establish X2 connection between the eNB's S1 connected to different MME's, we also lose out on the additional benefits provided by the X2 interface that includes Load Management, Mobility Parameters Management and the Mobility Robustness Optimization functionalities.

This solution adds value for the 5G NSA Deployments wherein data throughputs will be very high and X2 interface can be leveraged for fast convergence and help meet the latency requirements of 5G.

### Establishment of X2 Connection

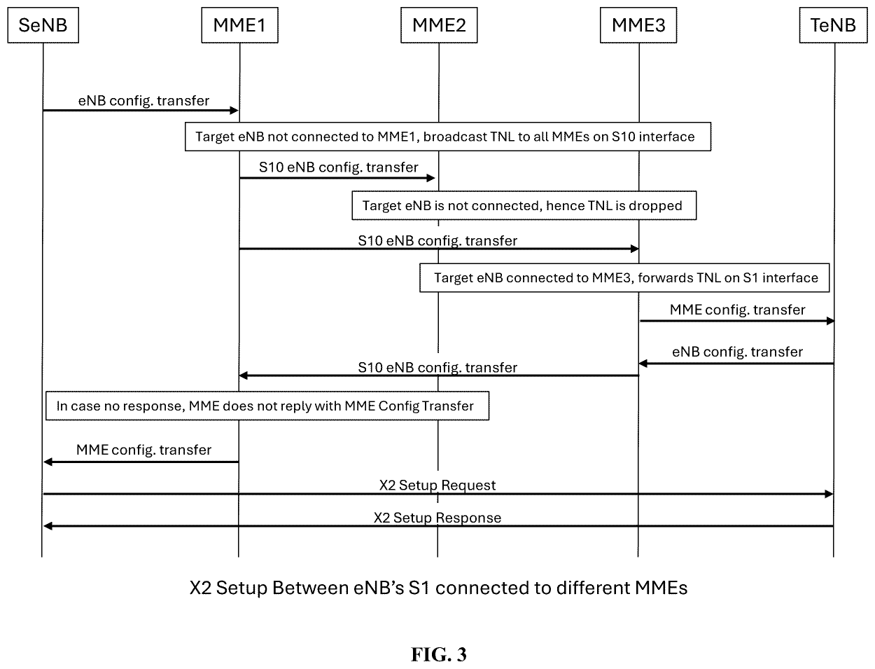

FIG. 3 is a call flow diagram for X2 setup between eNodeBs connected to different MMEs, in accordance with some embodiments.

As mentioned in the problem statement above the TNL discovery is successful only when Source and Target eNB's are connected to same MME. In order to solve this problem, we are suggesting a solution as depicted in the FIG. 1 and summarized below:

When eNB Configuration Transfer message is received at the MME1, it validates whether the Target eNB ID received in eNB Configuration Transfer is connected to (managed by) itself or not.

As per our problem statement, since the Target eNB won't be S1 connected to MME1 (to which Source eNB is connected), herein we propose to broadcast this eNB Configuration Transfer to all the MME's that are connected to the MME1 over S10 interface. Herein as per FIG. 1: MME2 and MME3 in our case. (Sec NOTE 1 for proposed S10 enhancement)

Both MME2 and MME3 will validate the Target eNB ID received in the S10 eNB Configuration Transfer and since MME2 does not have the S1 connection with this Target eNB, this S10 eNB Configuration Update message will be dropped at MME2, while MME3 has the S1 connection established with Target eNB, hence MME3 will initiate the S1 MME Configuration Transfer towards the Target eNB and in turn Target eNB will reply with the S1 eNB Configuration Transfer including the Transport Layer Address of the Target eNB.

MME3 on receiving this S1 eNB Configuration Transfer should initiate the S10 eNB Configuration Transfer towards MME1 which in turn will initiate S1 MME Configuration Transfer towards Source eNB including the Transport Layer Address of Target eNB.

Source eNB then initiates the X2 Setup Request towards the Target eNB on the endpoint details received in MME Configuration Transfer

### Target eNB Replies with X2 Setup Response

NOTE1: For this solution to work we are proposing an additional message on the S10 interface (working on the GTP-C Protocol) i.e S10 eNB Configuration Transfer message using which the Source MME can request the Transport Layer Address and the Target MME can reply with the Transport Layer Address as received from the Target eNB. Transport layer may be TCP/IP or preferably SCTP, in some embodiments.

### Inter-MME X2 Handover without SGW Change

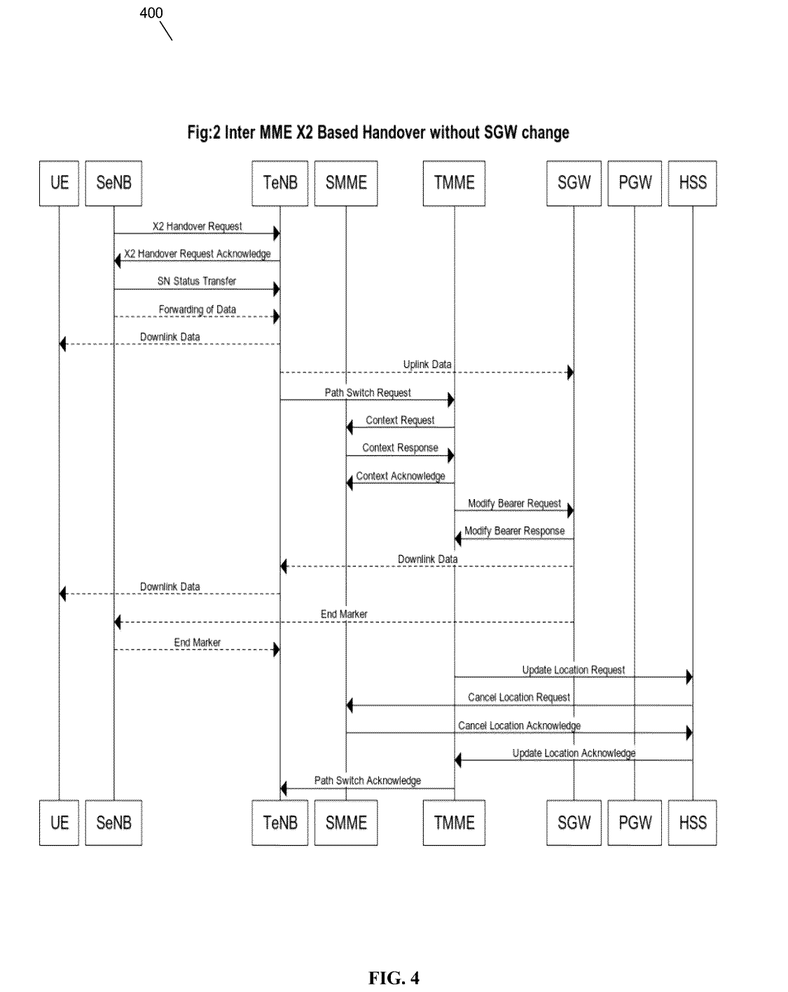

FIG. 4 is a call flow diagram for inter-MME X2-based handover without SGW change, in accordance with some embodiments.

Once the X2 connection is successfully established between eNB's S1 connected to different MME (as per the above-mentioned steps), next procedure is to successfully perform the Inter MME X2 Handover.

X2 Handover signaling happens b/w the Source and Target eNB as depicted in FIG. 4.

Once the UE has moved to the Target eNB, the Target eNB initiates Path Switch Request message. Path Switch Request message must include the GUMMEI (globally unique MME identifier) IE. (GUMMEI IE is received at Target eNB (Target eNB) in X2 HO Request message).

The Target MME using this GUMMEI identifies the Source MME and initiates Context Request on S10 interface towards the source MME. We are proposing an additional IE to be included in this Context Request message i.e, the Source MME UE S1AP ID which is received in the Path Switch Request message.

The Source MME should validate this Source MME UE S1AP ID and should publish the context details of that UE to the TARGET MME in Context Response message.

On receiving the Context Response, MME should acknowledge the UE context using Context Acknowledge and initiate Modify Bearer Request towards SGW (including new MME address and TEID).

SGW updates its bearer context and replies with Modify Bearer Response.

The TARGET MME updates the Location to the HSS that the UE has moved to the target MME and HSS in turn sends Cancel Location Request towards Source MME.

And the TARGET MME replies with the Path Switch Acknowledge message.

The Indirect Data forwarding during the Handover Execution Phase should continue as in the case of normal X2 Handover call flow as defined in 3GPP specification 23.401.

For this Solution to work it is expected that the Target eNB include the GUMMEI IE in the Path Switch Request message and Target MME should include an additional IE, e.g., Source MME UE S1AP ID in the Context Request message, that will be used by the Source MME to identify the UE Context. Alternatives and equivalents are also permitted and contemplated.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. In particular, the methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

The RAT for the base stations described herein may be 4G or 5G. The radio fronthaul interface may be Common Public Radio Interface (CPRI) or Enhanced Common Public Radio Interface (eCPRI). The second RAT may be 2G or 3G, and The radio fronthaul interface may be Common Public Radio Interface (CPRI) or Enhanced Common Public Radio Interface (eCPRI). The first and the second functional RU may be colocated on a single physical device and virtualized to operate as separate processes. The first and the second functional RU may be instantiated as virtualized containers.

The multi-RAT non-RT RIC may be coupled to a network operator service management and orchestration (SMO) functionality. The method may further comprise a multi-RAT central unit control plane (CU-CP) and multi-RAT central unit user plane (CU-UP).

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

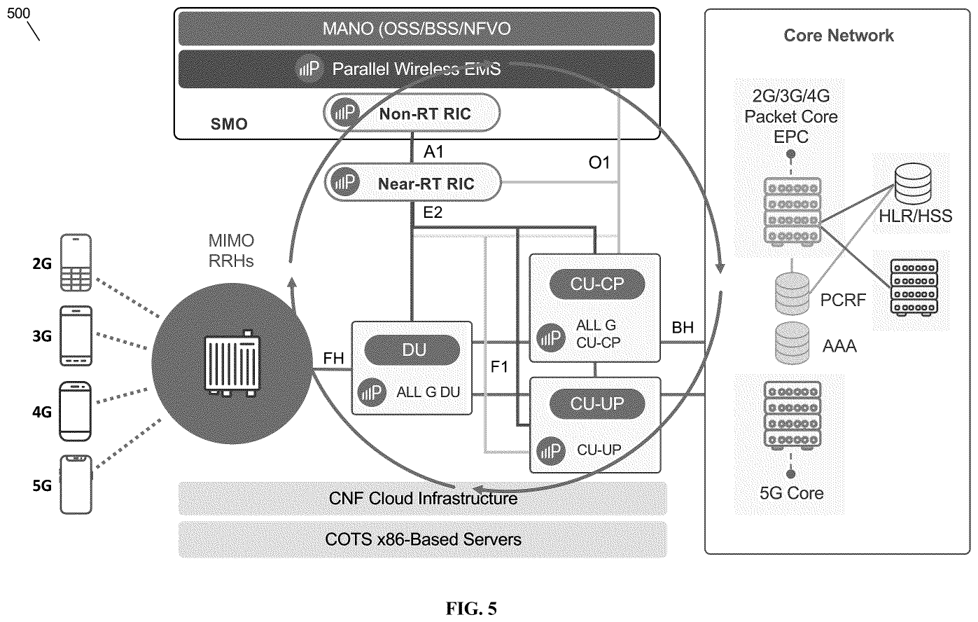

FIG. 5 is a schematic diagram of a multi-RAT RAN deployment architecture, in accordance with some embodiments. Multiple generations of UE are shown, connecting to RRHs that are coupled via fronthaul to an all-G Parallel Wireless DU, as described herein and in the other documents incorporated by reference herein. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure. In particular, where X2 is described herein, Xn and Xx are also contemplated as they are equivalent and handled by equivalent nodes in the RAN (eNB and gNB) and in the core (whether 5GC or 4G EPC).

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for handover across management entities, comprising:
receiving, at a first management entity, a message from a target base station reflecting a requested X2 handover, the message including a globally unique management entity identifier;
determining, at the first management entity, that the target base station identified in a received configuration transfer message from a source base station is not managed by the first management entity; and
receiving, at the first management entity, a transport layer address of the target base station from a second management entity,
thereby providing handover across management entities.

2. The method of claim 1, further comprising:
receiving, from the second management entity at the first management entity, a context request message; and
sending, to the second management entity from the first management entity, an S1AP identifier of a user equipment (UE) requesting handover to the target base station.

3. The method of claim 1, wherein the management entities are Long Term Evolution (LTE) mobility management entities (MMEs), the target base station is an LTE eNodeB, and the globally unique management entity identifier is a globally unique mobility management entity identifier (GUMMEI).

4. The method of claim 1, further comprising sending a broadcast configuration transfer message to multiple management entities connected to the first management entity to request the transport layer address of the target base station.

5. The method of claim 1, further comprising sending a configuration transfer initiation message to the source base station using the transport layer address of the target base station received from the second management entity.

6. The method of claim 1, further comprising causing a serving gateway (SGW) to complete a bearer context update for the UE reflecting that the UE has moved to the target base station.

7. The method of claim 1, further comprising performing data forwarding during a handover execution phase.

8. A computer-readable medium containing instructions which, when executed on a processor at a management entity in a mobile network, cause the management entity to perform operations, the operations comprising:
receiving, at a first management entity, a message from a target base station reflecting a requested X2 handover, the message including a globally unique management entity identifier;
determining, at the first management entity, that the target base station identified in a received configuration transfer message from a source base station is not managed by the first management entity; and
receiving, at the first management entity, a transport layer address of the target base station from a second management entity, thereby providing handover across management entities.

9. The computer-readable medium of claim 8, the instructions further comprising: receiving, from the second management entity at the first management entity, a context request message; and sending, to the second management entity from the first management entity, an S1AP identifier of a user equipment (UE) requesting handover to the target base station.

10. The computer-readable medium of claim 8, wherein the management entities are Long Term Evolution (LTE) mobility management entities (MMEs), the target base station is an LTE eNodeB, and the globally unique management entity identifier is a globally unique mobility management entity identifier (GUMMEI).

11. The computer-readable medium of claim 8, the instructions further comprising sending a broadcast configuration transfer message to multiple management entities connected to the first management entity to request the transport layer address of the target base station.

12. The computer-readable medium of claim 8, the instructions further comprising sending a configuration transfer initiation message to the source base station using the transport layer address of the target base station received from the second management entity.

13. The computer-readable medium of claim 8, the instructions further comprising causing a serving gateway (SGW) to complete a bearer context update for the UE reflecting that the UE has moved to the target base station.

14. The computer-readable medium of claim 8, the instructions further comprising performing data forwarding during a handover execution phase.
